(19) United States
(12) Patent Application Publication
(10) Pub. No.: US 2026/0025267 A1
(43) Pub. Date: Jan. 22, 2026

(54) METHOD AND SYSTEM FOR GENERATING ENHANCED LOGIN CREDENTIALS

(71) Applicant: Ian Crowley, Barcelona (ES)

(72) Inventor: Ian Crowley, Barcelona (ES)

(21) Appl. No.: 18/777,841

(22) Filed: Jul. 19, 2024

(51) Int. Cl. H04L 9/08

(52) U.S. Cl. CPC H04L 9/0872

(57) ABSTRACT

A method and system for password security enhancing by generating an enhanced password through the addition of a salt value derived from a user-selected geo-location. The method involves receiving a user-provided first key, generating a salt value corresponding to the selected geo-location, and appending the salt value to the first key. Subsequently, a hash operation is performed on the augmented key to generate an enhanced password that is more resistant to various password-based attacks.

### FIELD OF THE INVENTION

The present invention relates to data security, more specifically to generating secure login credentials using location-based information.

### BACKGROUND OF THE INVENTION

In the modern era of technology, it is crucial to prioritize the security of passwords to safeguard sensitive information and prevent unauthorized access to data. Conventional password-based authentication systems commonly rely on a combination of letters, numbers, and special characters, which can be vulnerable to brute force attacks or hacking methods that use dictionaries. Therefore, there is a requirement for an enhanced approach that strengthens password security and increases its resistance to unauthorized access attempts.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY OF THE INVENTION

A system and method for password security enhancement for user authentication on data systems is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates a system environment for enhancing a password security for authenticating a user, in accordance with an embodiment of the disclosure.

FIG. 2 illustrates a block diagram of central server 102, in accordance with an embodiment of the disclosure.

FIG. 3 illustrates a block diagram of user device 104, in accordance with an embodiment of the disclosure.

FIG. 4 is a Unified Modeling (UML) diagram for creating user credentials, in accordance with an embodiment of the disclosure.

FIG. 5 illustrates user interface 500 of user device 104, in accordance with an embodiment of the disclosure.

FIG. 6 illustrates user interface 600 of user device 104, in accordance with an embodiment of the disclosure.

FIG. 7 is geocode accuracy table 700, in accordance with an embodiment of the disclosure.

FIG. 8 is a flowchart showing a logical sequence of steps executed to perform a method for password security enhancing system.

FIG. 9 is a flowchart showing a logical sequence of steps to receive a selected location from a user and calculating a geocode from the received location.

### DETAILED DESCRIPTION

Embodiments of the present disclosure will now be described more fully hereinafter with reference to the accompanying drawings, in which some, but not all embodiments of the disclosure are shown. These disclosures may be embodied in many different forms and should not be construed as limited to the embodiments set forth herein; rather, these embodiments are provided so that this disclosure satisfies applicable patentability requirements. Like numbers refer to like elements throughout. The terminology used in this patent is not meant to be limiting insofar as devices described herein, or portions thereof, may be attached or utilized in other orientations.

The term “comprising” as used in this document indicates the inclusion of various elements without being restricted to them and its interpretation should align with its customary meaning in the context of patents. It is important to recognize that the use of expansive terms such as “comprising,” “including,” and “having” allows for the consideration of narrower terms like “consisting of,” “composition,” “consisting essentially of,” and “consisting essentially of.”

The phrases “in one embodiment,” “according to one embodiment,” “in some embodiments,” and similar expressions generally indicate a specific feature, structure, or characteristic that may be present in at least one embodiment of this disclosure. Thus, a particular feature, structure, or characteristic may be included in multiple embodiments of the disclosure, and these phrases do not necessarily refer to the same embodiment.

The word “exemplary” is used in this document to mean “serving as an example, instance, or illustration.” Any specific implementation described as “exemplary” should not be considered as preferred or advantageous over other implementations—

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Further details regarding certain embodiments of this disclosure are specified below, accompanied by corresponding illustrations. It should be noted that not all embodiments are depicted in the drawings, as this disclosure can take various forms beyond those presented here. These embodiments are included to ensure compliance with relevant legal requirements and should not be considered as restrictive to the embodiments mentioned herein. The same numbers are used to indicate similar elements consistently throughout. In this context, the term “apparatus” is used to refer to the user device in the example system. However, the components described in relation to the apparatus are also applicable to the methods and computer program products described in the claims. Therefore, the use of such terms should not be interpreted as limiting the breadth and scope of the embodiments of this disclosure.

In this document, the terms “data,” “content,” “information,” “electronic information,” “signals,” “commands,” and similar terms may be used interchangeably to refer to data that can be transmitted, received, and stored according to the embodiments of this invention. Therefore, the use of any of these terms should not restrict the scope or intention of the embodiments described in this disclosure. Additionally, when describing a first device receiving data from a second device, it should be understood that the data may be received directly from the second device or indirectly through one or more intermediate user devices (such as servers, relays, routers, network access points, base stations, hosts, etc., also referred to as a “network” in this document). Similarly, when describing a first device sending data to a second device, it should be understood that the data may be sent directly to the second device or indirectly through one or more intermediate user devices, such as servers, remote servers, cloud-based servers (e.g., cloud appliances), relays, routers, network access points, base stations, hosts, etc.

The existing password security systems use the real-time location of users as salt value to make password more secure. However, using the real-time location of users as a salt value for password security systems can introduce several drawbacks and potential security risks. Linking passwords to real-time location data raises significant privacy concerns. Users may be uncomfortable sharing their precise location information, as it can be intrusive and potentially abused if accessed by malicious entities. Storing such sensitive data increases the risk of unauthorized access and misuse. Salt values are random values added to passwords to prevent pre-computed attacks like rainbow tables. By using the real-time location as a salt value, the salt value space is limited to the range of possible locations, which may not provide sufficient entropy. This limitation weakens the effectiveness of the salt value in defending against various password attacks. Also, implementing a password security system that relies on real-time location as a salt value can be technically challenging and complex. It requires continuous tracking of users' location data and integrating it securely with the password authentication process. Users may also struggle to remember precise geographic locations. This complexity increases the likelihood of implementation errors and potential vulnerabilities. Considering these drawbacks, There is a need for a better solution. According to system and method disclosed herein, by converting the user selected geo-location(s) to geocodes and utilizing them as a salt value(s) to be appended to the regular alphanumeric password to create a new password. Such an approach overcomes the challenges raised by the existing solutions. Moreover, the disclosed system and method also provides the possibility of increasing the complexity of the password by adding geocodes for city, state, country along with the geocode of a user selected location

The system may also encompass security mechanisms to protect users. It may automatically prevent users from using certain geolocations to increase their security, blocking locations specific to the user, like home address or current location. Software services regularly record the Internet Protocol address (IP address) of new users to improve the security of future logins. The IP address can be geolocated and thus the security of the user's location selection is reduced as it can be deduced by the central system. The central system may also generate a blacklist of locations where an excessive number of users use a geocode as a memorable location, i.e. their team's home ground—This blacklist is used by the user's device and presented as zoned regions not available for select The user's device may automatically generate additional mapping movements to obfuscate cloud systems tracking of user locations. This obfuscation may extend to a cloud obfuscation solution, anonymizing all user mapping to the underlying mapping services.

Given the operational lifetime of user accounts, changes to users' memorable geographic locations may occur. For example, buildings and maps may change, so to support the user recalling their preferred location the central system will record the map version the user used to select their memorable locations and if necessary, display the record map version they recorded their memory location when the user is asked to recall it.

According to embodiments disclosed herein, a system and method for password security enhancement for user authentication is provided. The method using user selected geo-locations to increase the password complexity. The various embodiments describe a central server having a processor coupled to a memory device. A processor is communicatively coupled to the memory device. The processor is configured to execute the set of instructions to receive a first key from a user which is visible on a user interface of a display device, wherein the first key corresponds to a set of alphanumeric characters and special symbols. Further, the processor is configured to receive a salt value corresponding to a geo-location selected by a user on a geo-referenced image. Also, the processor is configured to calculate a geocode of the corresponding to the user selected geo-location which represents the salt value, Additionally, the processor is configured to generate an augmented key to generate an augmented key by appending the salt value to the first key. Moreover, the processor is configured to perform a hash operation on the augmented key to generate an enhanced password.

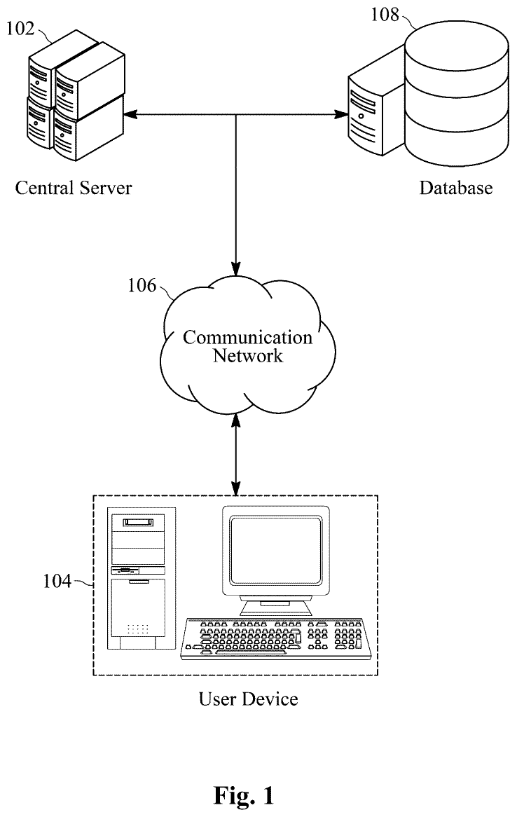

FIG. 1 is a block diagram that illustrates a system environment for enhancing a password security for authenticating a user, in accordance with an embodiment of the disclosure. Referring to FIG. 1 there is shown a system environment 100, which includes central server 102, user device 104, communication network 106, and database 108. Central server 102, user device 104, and database 108 may be communicatively coupled with each other through communication network 106.

Central server 102 may comprise a suitable logic, circuitry, interfaces, and/or code that may be configured to retrieve information from database 108. For example, central server 102 may be configured to store and authenticate user credentials, of a data system, from database 108. Additionally or alternatively, central server 102 may be configured to receive user credentials from a user for creation of a user account. The user credentials include a userID and a password. In an embodiment, the password includes a combination of both user-supplied alphanumeric characters and/or special symbols along with gecode(s) details selected by a user. Additionally, the password is received and stored in an encrypted format. The encryption may be any of the hash algorithms when it is received by the server. Additionally, central server 102 is configured to communicate a user interface to the user device for creating the user account.

Hash algorithms play a critical role in encryption and cryptographic systems, providing a secure and efficient way to transform data into a fixed-size numerical representation called a hash value or digest. These algorithms are designed to be one-way functions, meaning that it is computationally infeasible to derive the original input from the hash value. Hash algorithms are widely used in various security applications, including password storage, digital signatures, and data integrity verification. Hash algorithms are deterministic in nature and produce the same hash value for the same input every time. Additionally, even a minor change in the input data should produce a significantly different hash value, ensuring that even a small alteration will result in a completely different digest. Hash algorithms offer significant resistance to collision attacks, thus no two different inputs will produce the same hash value. Hence, the hash algorithm makes it practically impossible to find collisions, even with powerful computational resources. In an embodiment, some of the commonly used hash algorithms, but not limited to, include MD5 (Message Digest 5), SHA-I (Secure Hash Algorithm 1), SHA-256 (Secure Hash Algorithm 256-bit), and SHA-3 (Secure Hash Algorithm 3).

A person having ordinary skills in the art would appreciate that database 108 includes one or more fields (that in some examples corresponds to columns of a tuple and/or table in the database) within which the information is stored. Database 108 may comprise suitable logic, circuitry, interfaces, and/or code that may be configured to store information in a structured format. Some examples of database 108 may include, but not limited to, Mysql@, MongoDB@, and/or the like. In some examples, the scope of the disclosure is not limited to database 108 being a separate from central server 102. In an example embodiment, database 108 may be implemented on central server 102.

User device 104 may comprise suitable logic, circuitry, interfaces, and/or code that may be configured to receive a user interface (UI) from central server 102. Through the UI, user device 104 may be configured to receive user credentials from a user. In an embodiment, user device 104 may be configured to transmit the user credentials to central server 102 via communication network 106. User device 104 is configured to receive a first key from a user. In an embodiment, the first key is a traditional password involving a combination of alphanumeric characters or special characters. Further, user device 104 is configured to generate a salt value. A salt value is a random value that is added to a password before it is hashed. The purpose of using a salt value is to add an extra layer of security to password storage. Additionally, in order to generate a salt value, user device 104 is configured to receive a geo-location, selected by the user, on a georeferenced image. Subsequently, the user device is configured to calculate a geocode corresponding to the selected geo-location. In an embodiment, each geo-location on the georeferenced image is depicted as a map grid having a plurality of cells, and wherein each cell is associated with a corresponding geocode. In an embodiment, the geocode of the selected geolocation is the generated salt value.

Once the geocode has been generated, user device 104 is configured to generate an augmented key by appending the salt value to the first key. Thereafter, the user device is configured to encrypt the augmented key by performing a hash operation in order to generate an enhanced password. Post the generation of the enhanced password, user device 104 is configured to transmit the enhanced password to central server 102 via communication network 106.

Examples of user device 104 may include, but are not limited to, a personal computer, a laptop, a personal digital assistant (PDA), a mobile device, a tablet, or any other user device.

In an embodiment, communication network 106 may include a communication medium through which each user device 104 may communicate with central server 102 and database 106. Such communication may be performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G, 5G, 6G cellular communication protocols, and/or Bluetooth (BT) communication protocols. Communication network 106 may include, but is not limited to, the Internet, a cloud network, a Wireless Fidelity (WI-Fi) network, a Wireless Local Area Network (WLAN), a Local Area Network (LAN), a telephone line (POTS), and/or a Metropolitan Area Network (MAN).

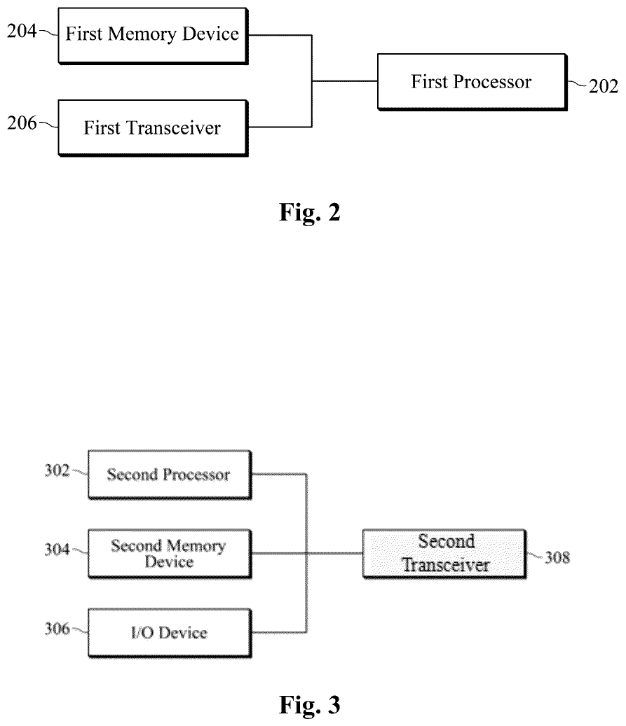

FIG. 2 illustrates a block diagram of central server 102, according to one or more embodiments illustrated herein. Central server 102 includes first processor 202, first memory device 204, and first transceiver 206. First processor 202 may be embodied as one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit (ASIC) or field programmable gate array (FPGA), or some combination thereof.

Accordingly, although illustrated in FIG. 2 as a single controller, in an exemplary embodiment, first processor 202 may include a plurality of processors and signal processing modules. The plurality of processors may be embodied on a single user device or may be distributed across a plurality of user devices collectively configured to function as the circuitry of central server 102. The plurality of processors may be in communication with each other and may be collectively configured to perform one or more functionalities of the circuitry of central server 102, as described herein. In an exemplary embodiment, first processor 202 may be configured to execute instructions stored in first memory device 204 or otherwise accessible to first processor 202. These instructions, when executed by first processor 202, may cause the circuitry of central server 102 to perform one or more of the functionalities, as described herein.

Whether configured by hardware, firmware/software methods, or by a combination thereof, first processor 202 may include an entity capable of performing operations according to embodiments of the present disclosure while configured accordingly. Thus, for example, when first processor 202 is embodied as an ASIC, FPGA or the like, first processor 202 may include specifically configured hardware for conducting one or more operations described herein. Alternatively, as another example, when first processor 202 is embodied as an executor of instructions, such as may be stored in first memory device 204, the instructions may specifically configure first processor 202 to perform one or more algorithms and operations described herein.

Thus, first processor 202 used herein may refer to a programmable microprocessor, microcomputer or multiple processor chip or chips that may be configured by software instructions (applications) to perform a variety of functions, including the functions of the various embodiments described above. In some devices, multiple processors may be provided that may be dedicated to wireless communication functions and one processor may be dedicated to running other applications. Software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. The memory can also be located internal to another computing resource (e.g., enabling computer readable instructions to be downloaded over the Internet or another wired or wireless connection)—

First memory device 204 may include suitable logic, circuitry, and/or interfaces that are adapted to store a set of instructions that is executable by first processor 202 to perform predetermined operations. Some of the commonly known memory implementations include, but are not limited to, a hard disk, random access memory, cache memory, read only memory (ROM), erasable programmable read-only memory (EPROM) & electrically erasable programmable read-only memory (EEPROM), flash memory, magnetic cassettes, magnetic tape, magnetic disk storage or other magnetic storage devices, a compact disc read only memory (CD-ROM), digital versatile disc read only memory (DVD-ROM), an optical disc, circuitry configured to store information, or some combination thereof. In an exemplary embodiment, first memory device 204 may be integrated with first processor 202 on a single chip, without departing from the scope of the disclosure. In an embodiment, first memory device 204 and database 108 may be same devices.

First transceiver 206 may correspond to a communication interface that may facilitate transmission and reception of messages and data to and from various devices (e.g., user device 104). Examples of first transceiver 206 may include, but are not limited to, an antenna, an Ethernet port, a USB port, a serial port, or any other port that can be adapted to receive and transmit data. First transceiver 206 transmits and receives data and/or messages in accordance with the various communication protocols, such as, Bluetooth®, Infra-Red, 12C, TCP/IP, UDP, and 2G, 3G, 4G or 5G communication protocols.

In operation, first processor 202 is configured to receive user credentials from user device 104. The user credentials are stored in first memory device 204 using various security measures to protect the sensitive information. Instead of storing passwords in plain text, the hash values of the user credentials are stored such that passwords cannot be easily retrieved. In some cases, secure password storage systems employ strong cryptographic hash functions such as bcrypt, scrypt, or Argon2. Such algorithms are purposely designed to be computationally expensive, slowing down brute-force and dictionary attacks. In another embodiment, first processor 202 is configured to present a user interface to the user device 204 to enable the user device to input the user credentials-In an exemplary embodiment, the user interface allows the user to input characters, special symbols, and numbers. In another embodiment, the user interface presents a georeferences map for selection of geo-location by a user.

FIG. 3 illustrates a block diagram of user device 104, according to one or more embodiments illustrated herein. User device 104 includes second processor 302, second memory device 304, I/O Device 306, and second transceiver 308. Second processor 302 may be embodied as one or more microprocessors with accompanying digital signal processor(s), one or more processor(s) without an accompanying digital signal processor, one or more coprocessors, one or more multicore processors, one or more controllers, processing circuitry, one or more computers, various other processing elements including integrated circuits such as, for example, an application specific integrated circuit (ASIC) or field programmable gate array (FPGA), or some combination thereof.

Accordingly, although illustrated in FIG. 3 as a single controller, in an exemplary embodiment, second processor 302 may include a plurality of processors and signal processing modules. The plurality of processors may be embodied on a single electronic device or may be distributed across a plurality of electronic devices collectively configured to function as the circuitry of user device 104. The plurality of processors may be in communication with each other and may be collectively configured to perform one or more functionalities of the circuitry of user device 104, as described herein. In an exemplary embodiment, second processor 302 may be configured to execute instructions stored in second memory device 304 or otherwise accessible to second processor 302. These instructions, when executed by second processor 302, may cause the circuitry of user device 104 to perform one or more of the functionalities, as described herein.

Whether configured by hardware, firmware/software methods, or by a combination thereof, second processor 302 may include an entity capable of performing operations according to embodiments of the present disclosure while configured accordingly. Thus, for example, when second processor 302 is embodied as an ASIC, FPGA or the like, second processor 302 may include specifically configured hardware for conducting one or more operations described herein. Alternatively, as another example, when second processor 302 is embodied as an executor of instructions, such as may be stored in second memory device 304 the instructions may specifically configure second processor 302 to perform one or more algorithms and operations described herein.

Thus, second processor 302 used herein may refer to a programmable microprocessor, microcomputer or multiple processor chip or chips that may be configured by software instructions (applications) to perform a variety of functions, including the functions of the various embodiments described above. In some devices, multiple processors may be provided that may be dedicated to wireless communication functions and one processor may be dedicated to running other applications. Software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. The memory can also be located internal to another computing resource (e.g., enabling computer readable instructions to be downloaded over the Internet or another wired or wireless connection).

Second memory device 304 may include suitable logic, circuitry, and/or interfaces that are adapted to store a set of instructions that are executable by second processor 302 to perform predetermined operations. Some of the commonly known memory implementations include, but are not limited to, a hard disk, random access memory, cache memory, read only memory (ROM), erasable programmable read-only memory (EPROM) & electrically erasable programmable readonly memory (EEPROM), flash memory, magnetic cassettes, magnetic tape, magnetic disk storage or other magnetic storage devices, a compact disc read only memory (CD-ROM), digital versatile disc read only memory (DVD-ROM), an optical disc, circuitry configured to store information, or some combination thereof. In an exemplary embodiment, second memory device 304 may be integrated with second processor 302 on a single chip, without departing from the scope of the disclosure,

I/O Device 306 may correspond to a set of input and out devices which may facilitate receiving from and presenting information to a user. The input device may be, but not limited to, a mouse, a keyboard, a stylus, a touch screen, a track pad, joystick, a GPS receiver, etc. The output device may include a high-resolution display that employs advanced pixel arrangements, such as RGB (Red-Green-Blue) or PenTile matrix, to enhance image clarity and eliminate color artifacts. The display may suppon various resolutions, ranging from standard HD (High Definition) to Ultra HD (4K) or beyond, depending on the requirements of the user device and application. The display device may also incorporate touch-sensitive capabilities, utilizing a capacitive or resistive touch panel to enable precise touch input. It supports multi-touch gestures, such as pinch-to-zoom, swipe, and rotation, facilitating intuitive interactions with user interfaces and applications.

Second transceiver 308 may correspond to a communication interface that may facilitate transmission and reception of messages and data to and from various devices (e.g., user device 104). Examples of the second transceiver 306 may include, but are not limited to, an antenna, an Ethernet port, a USB port, a serial port, or any other port that can be adapted to receive and transmit data. The second transceiver 306 transmits and receives data and/or messages in accordance with the various communication protocols, such as, Bluetooth®, Infra-Red, 12C, TCP/IP, UDP, and 2G, 3G, 4G or 6G communication protocols.

In operation, second processor 302 is configured to receive user credentials from the user—The user credentials may include both, a userID and a password. Second processor 302 is further configured to receive a first key from the user via the I/O device 306-In an embodiment, the first key may be a user-provided passphrase that includes a combination of alphanumeric characters and special symbols. Further, second processor 302 is configured to generate a salt value corresponding to a geo-location. In an embodiment, the salt value is a geo-location selected by the user on the geo-referenced image. The geo-location may be a memorable location to the user. The geo-referenced image represents locations as a map grid with multiple cells, where each cell associated with a corresponding geocode. Furthermore, second processor 302 calculates a geocode corresponding to the user-selected geo-location to incorporate geographic information as the salt value. Furthermore, second processor 302 is configured to generate an augmented key by appending the salt value to the first key. Subsequently, second processor 302 is configured to encrypt the augmented key by performing a hash operation on the augmented key in order to generate an enhanced password. In another embodiment, the geocode may be configured to restrict the accuracy of the map to maintain consistency and security. In yet another embodiment, second processor 302 may be configured to salt value additional geocode information to the password. The additional geocode information may correspond to the city, state, or country of the user selected geo-location.

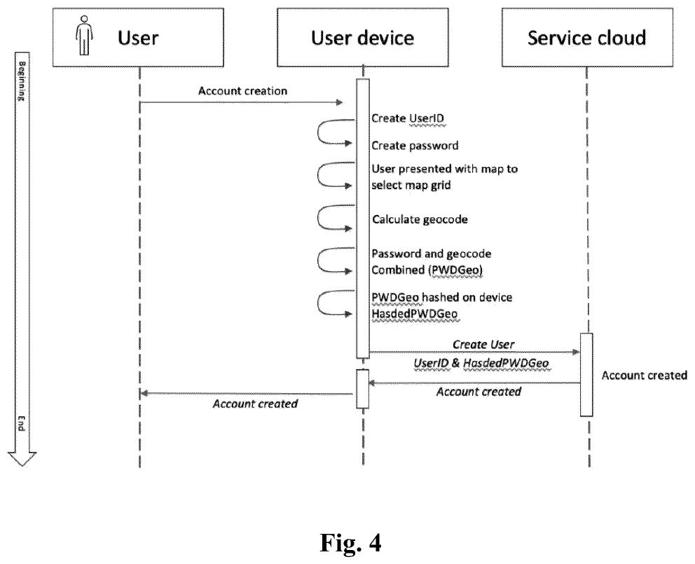

FIG. 4 illustrates a Unified Modeling (UML) diagram for creating user credentials, according to one or more embodiments illustrated herein. FIG. 4 illustrates that user device 104 receives a request from a user to generate user credentials corresponding to data services. User device 104 provides a user interface to the user and receives a user-chosen UserID as input. Subsequently, the user is requested to input a passphrase. User device 104 is configured to receive alphanumeric characters and special symbols as the passphrase. Further, user device 104 presents a georeferenced map to the user for selection of a geo-location. Thereafter, user device 104 receives a user selected geo-location on the geo-referenced map. Based on the selected geo-location, a corresponding geocode is calculated by user device 104, This calculated geocode is combined with the passphrase to generate the augmented key. Furthermore, user device 104 is configured to encrypt the augmented key using hash operation. A hashed valUe is generated corresponding to the combination and the hashed value is sent to central server 102 for creation of the user credentials. Subsequently, the user credentials are stored in the central server and are communicated to user device 104.

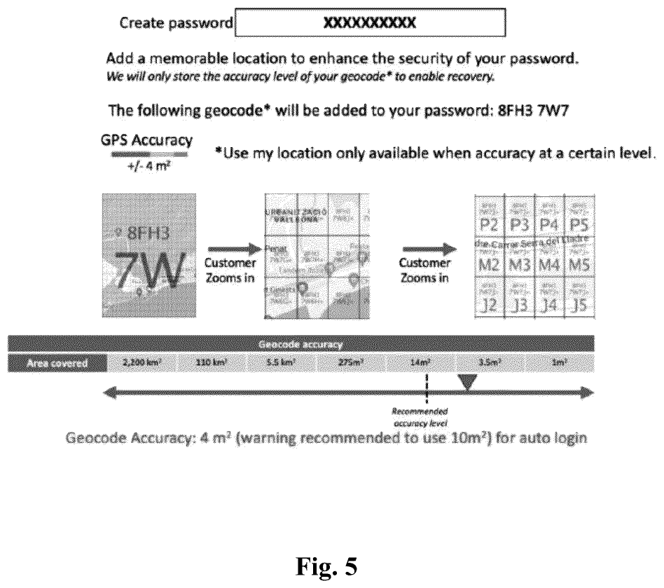

FIG. 5 illustrates user interface 500 of a user device 104, according to one or more embodiments illustrated herein. User interface 500 is configured to receive a first key from the user. The first key can be a passphrase that includes a combination of alphanumeric characters and special symbols. Further, the user interface includes geo-referenced map 504, wherein the user can select a geo-location. Each location on the geo-referenced image is depicted as a map grid having a plurality of cells, and wherein each cell is associated with a corresponding geocode-Based on the user selection, the geocode is generated and displayed on user interface 500. User interface 500 allows geo-location selection only when a predefined accuracy is available. The geocode acts as salt value that is added to a password. In an embodiment, the salt value is a random data input that is used in conjunction with a passphrase when creating a cryptographic hash value. Salt value adds complexity and increases the security of the resulting hashed password. The salt value is then appended to the passphrase and thereafter hashed to generate a stronger password.

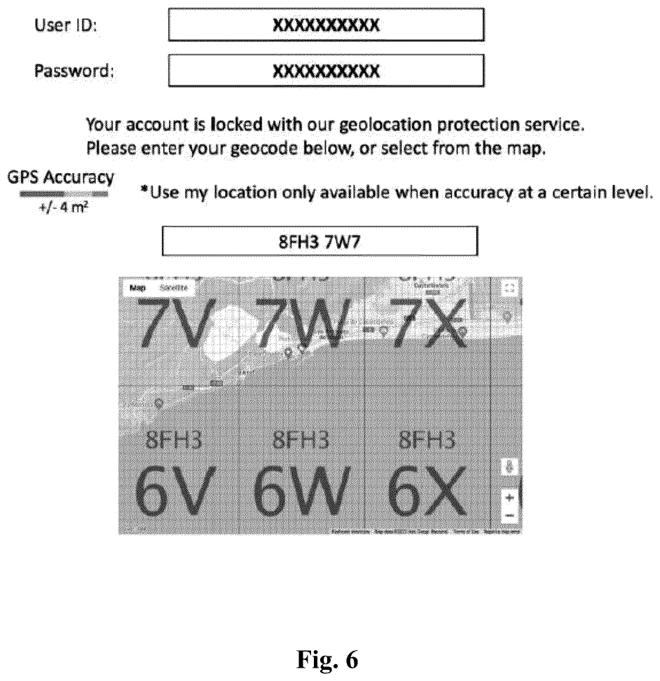

FIG. 6 illustrates user interface 600 of user device 104, according to one or more embodiments illustrated herein. At the time of authentication of user credentials, according to one or more embodiments illustrated herein. User interface 600 is configured to receive the UserID and the first key from the user. Further, the user interface is configured to receive a salt value, i.e., a geolocation, on a geo-referenced map, from the user. Based on correct details of the first key and the geo-location, the user is authenticated to the data system. In an embodiment, the user interface is configured to receive the salt value via an input of the geocode in the salt value block.

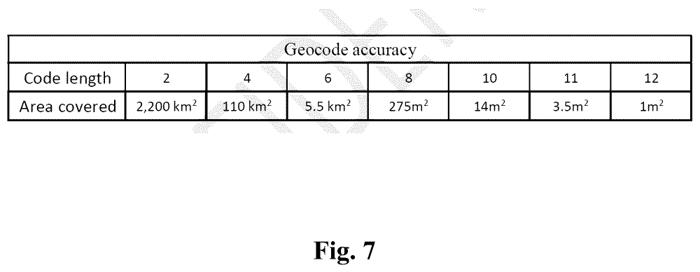

FIG. 7 illustrates geocode accuracy table 700, according to one or more embodiments illustrated herein. The geocode accuracy table discloses a code length associated with an area covered. As the accuracy increases, the area covered during geo-location selection by the user reduces and the code length increases. To avoid authentication challenges, the accuracy may be predefined.

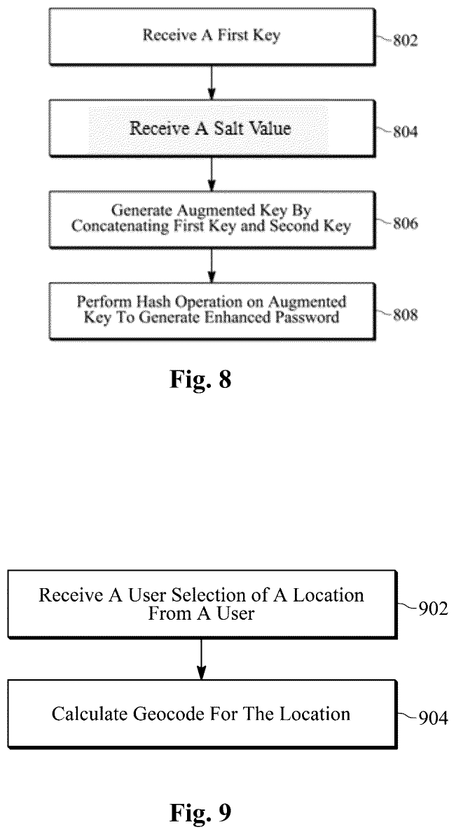

FIG. 8 illustrates flowchart 800 of a method for password security enhancing system 100, according to one or more embodiments illustrated herein. At 802, a text input pertaining to a first key is received by second processor 302 from the user. In an example embodiment, the first key includes a combination of alphanumeric characters and/or special symbols. At 804, a salt value, corresponding to a geo-location, is generated by second processor 302 In an example embodiment, the salt value corresponds to a user selected geo-location on the geo-referenced image. In another embodiment, the salt value includes a geocode of the city, state or country of the selected geo-location. At 806, an augmented key is generated, by second processor 302, by appending the salt value to the first key. At 808, a hash operation is performed, by the second processor, on the augmented key to generate an enhanced password. Thereafter, these authentication details, i.e. the enhanced password along with the associated userID, are communicated to the central server 104, where first processor 202 processes the password and the userID and thereafter stores them in database 108.

FIG. 9 illustrates flowchart 900 of a method for generating the salt value for password security enhancing system 100. At 902, a geo-location is received, by second processor 302, based on a geo-location selected by the user on a geo-referenced image. At 904, the geocode corresponding to the user selected geo-location is calculated by the second processor. In an exemplary embodiment each location on the geo-referenced image is depicted as a map grid having a plurality of cells, and wherein each cell is associated with a corresponding geocode. In another embodiment, the geo-location selection is restricted to a predefined accuracy.

The foregoing method descriptions and the process flow diagrams are provided merely as illustrative examples and are not intended to require or imply that the operations of the various embodiments must be performed in the order presented. As will be appreciated by one of skill in the art, the operations may be performed in one or more different orders without departing from the various embodiments of the disclosure.

Methods according to the above-described examples can be implemented using computer executable instructions that are stored or otherwise available from computer readable media. When stored on a computer readable media, these instructions are physically embodied on the media as data structures. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

The hardware used to implement the various illustrative logics, logical blocks, modules, and circuits described in connection with the aspects disclosed herein may include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of user devices, e.g., a combination of a DSP and a microprocessor, a plurality of microprocessors, one or more microprocessors in conjunction with a DSP core, or any other such configuration, Alternatively, or in addition, some operations or methods may be performed by circuitry that is specific to a given function.

In one or more exemplary embodiments, the functions described herein may be implemented by special-purpose hardware or a combination of hardware programmed by firmware or other software. In implementations relying on firmware or other software, the functions may be performed as a result of execution of one or more instructions stored on one or more nontransitory computer-readable media and/or one or more non-transitory processor-readable media. These instructions may be embodied by one or more processor-executable software modules that reside on the one or more non-transitory computer-readable or processor-readable storage media. Non-transitory computer-readable or processor-readable storage media may in this regard comprise any storage media that may be accessed by a computer or a processor. By way of example but not limitation, such non-transitory computer-readable or processor-readable media may include RAM, ROM, EEPROM, FLASH memory, disk storage, magnetic storage devices, or the like. Disk storage, as used herein, includes compact disc (CD), laser disc, optical disc, digital versatile disc (DVD), floppy disk, and Blu-ray Disc TM or other storage devices that store data magnetically or optically with lasers. Combinations of the above types of media are also included within the scope of the terms non-transitory computer-readable and processor-readable media. Additionally, any combination of instructions stored on the one or more non-transitory processor readable or computer-readable media may be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the operations in the method described above may not necessarily occur in the order depicted in the accompanying diagrams, and in some cases one or more of the operations depicted may occur substantially simultaneously, or additional operations may be involved. Although specific terms are employed herein, they are used in a generic and descriptive sense only and not for purposes of limitation.

What is claimed is:

1. A method for enhancing password security for user authentication, comprising:
receiving, by a processor, a first key from a user; generating, by the processor, a salt value corresponding to a geo-location(s); generating, by the processor, an augmented key by appending the salt value to the first key; and performing a hash operation, by the processor, on the augmented key, to generate an enhanced password.

2. The method of claim 1, wherein the first key includes a combination of alphanumeric characters and special symbols.

3. The method of claim 1, wherein generating the salt value comprises:
receiving, by the processor, a geo-location selected by the user on a georeferenced image; and
calculating, by the processor, a geocode corresponding to the user selected geolocation.

4. The method of claim 3, wherein each geo-location on the geo-referenced image is depicted as a map grid having a plurality of cells, and wherein each cell is associated with a corresponding geocode.

5. The method of claim 3, wherein the geo-location selection is restricted to a predefined accuracy.

6. The method of claim 3, wherein the salt value includes a geocode of a city, state or country of the selected geo-location.

7. A password security enhancing system, comprising:
a memory for storing executable instructions; and
a processor, coupled communicatively to a display device and the memory, configured to execute instructions stored in the memory to: receive a first key from a user; generate a salt value corresponding to a geo-location; generate an augmented key by appending the salt value to the first key; and perform a hash operation on the augmented key and generate an enhanced password.

8. The system of claim 7, wherein the first key includes a combination of alphanumeric characters and special symbols.

9. The system of claim 7, wherein the salt value comprises a geo-location selected by the user on a geo-referenced image; and wherein a geocode is calculated corresponding to the user selected geo-location.

10. The system of claim 9, wherein each geo-location on the geo-referenced image is depicted as a map grid having a plurality of cells, and wherein each cell is associated with a corresponding geocode.

11. The system of claim 9, wherein each geo-location is restricted to a predefined accuracy.

12. The system of claim 9, wherein the salt value includes a geocode for a city, state or country of the geo-location.

13. A non-transitory computer-readable storage medium storing instructions which, when executed by a computing device, cause the computing device to perform steps of:
receiving, by a processor, a first key from a user;
generating, by the processor, a salt value corresponding to a geo-location; generating, by the processor, an augmented key by appending the salt value to the first key; and
generating an enhanced password by performing a hash operation on the augmented key.

14. The non-transitory computer-readable storage medium of claim 13, wherein generating the salt value comprises:
receiving, by the processor, a geo-location selected by the user on a georeferenced image; and
calculating, by the processor, a geocode corresponding to the user-selected geolocation.

15. The non-transitory computer-readable storage medium of claim 13, wherein each geolocation on a geo-referenced image is depicted as a map grid having a plurality of cells, and wherein each cell is associated with a corresponding geocode.

16. The non-transitory computer-readable storage medium of claim 13, wherein the geolocation selection is restricted to a predefined accuracy.

17. The non-transitory computer-readable storage medium of claim 13, wherein the salt value includes a geocode of a city, state or country of the geo-location.
